(19) United States
(12) Patent Application Publication
(10) Pub. No.: US 2007/0123158 A1
(43) Pub. Date: May 31, 2007

(54) Louver driver for swing register

(75) Inventors: Minoru Shibata, Aichi-ken (JP); Katsuhiro Suhara, Aichi-ken (JP); Hiroaki Ando, Aichi-ken (JP); Shinji Kumazawa, Aichi-ken (JP); Yasuhiro Sakakibara, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 11/604,883

(22) Filed: Nov. 28, 2006

(30) Foreign Application Priority Data
Nov. 30, 2005 (JP) 2005-347049

(51) Int. Cl. B60J 1/20

(52) U.S. Cl. 454/130

(57) ABSTRACT

Vertical louvers are swingably supported at a duct outlet of a vehicle air conditioner. Two left and right shape-memory alloy (SMA) wires are coupled to a swing shaft of one of the vertical louvers. When electrically heated, the SMA wires contract, and the swing shaft is rotated, accordingly. The SMA wires are alternately supplied with electricity, so that the vertical louvers are swung leftward and rightward.

### BACKGROUND OF THE INVENTION

The present invention relates to a louver driver used in a swing register for swinging louvers that are pivotally supported at an outlet of a duct for conducting air from an air conditioner, thereby changing the course of the airflow.

A swing register is typically used is vehicle air conditioners. A swing register has vertical louvers and lateral louvers at the outlet of the airflow passage of an air conditioner. The swing register swings vertical louvers by means of an actuator to change the direction of the airflow. Conventionally, as disclosed in Japanese Patent No. 3187719, Japanese Patent No. 332409, Japanese Laid-Open Patent Publication No. 2002-2211232, and Japanese Laid-Open Utility Model Publication No. 7-10188, a motor is typically used as the actuator for driving the louvers of such a swing register.

FIG. 7 shows one example of the louver driver of a conventional swing register that uses a DC motor as the actuator for driving the louvers. As shown in FIG. 7, an output shaft 50a of the DC motor 50, which generates axial force, is coupled to a reduction mechanism 51 constructed by gears. A final gear 51a of the reduction mechanism 51 is coupled to a crank mechanism 52 that converts rotation into swinging motion. A wire rod 54 is coupled to the crank mechanism 52. A rack 53 is fixed to the distal end of the wire rod 54 such that the wire rod 54, together with the rack 53, reciprocates. A first pinion 55a is connected to the crank mechanism 52 through the rack 53. A second pinion 55b is rotatably supported to be coaxial with the rotary shaft of the first pinion 55a. The second pinion 55b is meshed with a gear 56, to which a swing shaft 57a of a louver 57 is fixed. The swing shaft 57a integrally pivots with the gear 56. The first and second pinions 55a, 55b are pressed against each other by a spring, so that rotational force can be transmitted therebetween by means of frictional force. Also, the first and second pinions 55a, 55b are configured as a clutch mechanism that, when an occupant of the vehicle manually swings the louver 57, permits relative rotation between the pinions 55a, 55b.

In a conventional swing register as described above, which uses a motor as a louver driving actuator, noises from the motor and the reduction mechanism leak into the passenger compartment. It is therefore necessary to take measures for insulating noises. For example, a sound insulation member made of, for example, rubber, is put around the motor. Alternatively, the motor and the reduction mechanism are contained in a case. These configurations increase the number of components. As a result, the manufacturing costs and the size of the device are increased.

### SUMMARY OF THE INVENTION

Accordingly, it is an objective of the present invention to provide a swing register that readily and reliably reduces noises generated when louvers are operated.

In accordance with one aspect of the present invention, a louver driver used in a swing register that swings louvers that are pivotally supported at an airflow passage of an air conditioner, thereby changing the course of the airflow, is provided. The louver driver includes a shape-memory alloy member that is extended and contracted when electrically heated. The shape-memory alloy member and the louver are coupled to each other such that the louver is swung in accordance with extension and contraction of the shape-memory alloy.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a plan view illustrating the overall structure of a louver driver in a swing register according to one embodiment of the present invention;

FIG. 2 is a diagrammatic view showing the electrical circuit of the louver driver of the swing register according to the embodiment of FIG. 1;

FIG. 3 is a graph of the temperature versus strain of the shape-memory alloy used in the embodiment of FIG. 1;

FIGS. 4A and 4B are plan views schematically showing operation of the louver driver of the swing register according to the embodiment of FIG. 1;

FIGS. 5A and 5B are plan views showing operation of a current shutoff mechanism used in the embodiment of FIG. 1;

FIG. 6 is a plan view illustrating the overall structure of a louver driver in a swing register according to another embodiment of the present invention; and

FIG. 7 is a plan view illustrating the overall structure of a prior art louver driver.

### DETAILED DESCRIPTION OF THE PREFERRED EMBODIMENTS

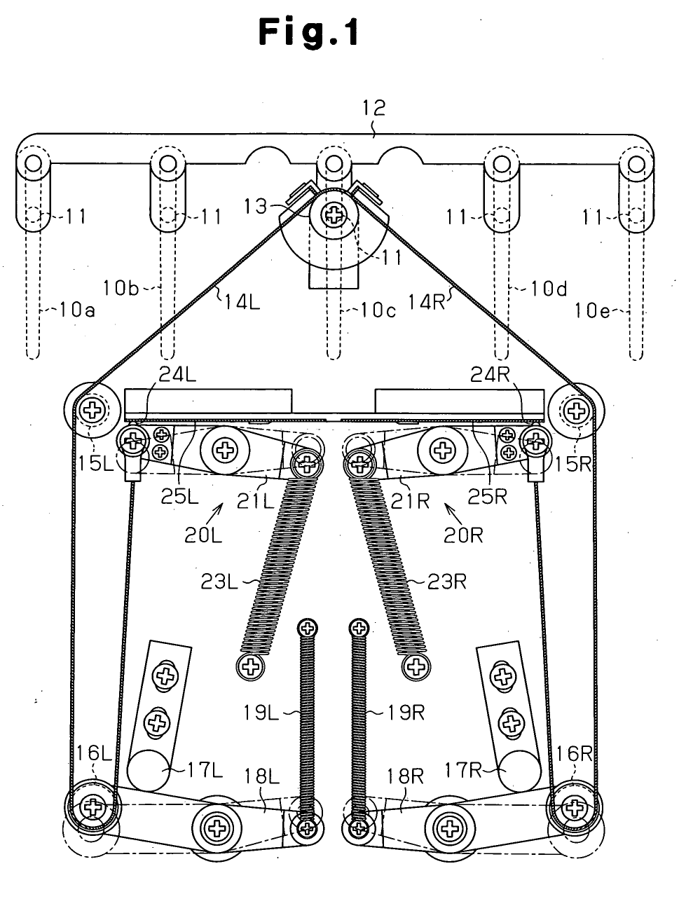

A louver driver of a swing register according to one embodiment of the present invention will be described with reference to FIGS. 1 to 5B.

The louver driver of the swing register according to this embodiment is located at the outlet of airflow passage (duct) of a vehicle air conditioner. Vertical and lateral louvers are provided at the outlet. The louver driver laterally swings the vertical louvers to change the direction of airflow into the passenger compartment.

In this embodiment, the swinging motion of the vertical louvers in the swing register is achieved by means of contraction of a shape-memory alloy (SMA) caused by electrically heating the alloy. As the shape-memory alloy, thin wires of a titanium-nickel based alloy are used. In this louver driver, when the vertical louvers are moved by using contraction of the shape-memory alloy caused by electrically heating the alloy, the alloy produces no noise. Therefore, without any special noise reduction measures, the noise of the operation of the vertical louvers is reduced. As a result, no sound insulating member is required. This reduces the weight, the occupied space, and the number of components of the louver driver.

FIG. 1 shows the entire construction of the louver driver of the swing register according to the present embodiment. In the following, a side of the louver driver facing the outlet of an airflow passage (duct) of a vehicle air conditioner is referred to as a front side, and the opposite side is referred to as a rear side.

At the outlet of an air flow passage (duct) of a vehicle air conditioner, lateral louvers (not shown) are provided. The lateral louvers are supported to be vertically swingable. Also, at the outlet, vertical louvers 10a to 10e, the number of which is five in this embodiment, are provided. Each vertical louver 10a to 10e is laterally swingable about a swing shaft 11. The slat-like vertical louvers 10a to 10e include a main louver 10c provided at the center and follower louvers 10a, 10b, 10d, and 10e provided at both sides of the main louver 10c. Each of the louvers 10a to 10e has a swing shaft 11. The main louver 10c and the follower louvers 10a, 10b, 10d, 10e are mechanically coupled to one another by means of a link mechanism 12, so that the vertical louvers 10a to 10e are synchronously swingable.

The swing shaft 11 of the main vertical louver 10c is fixed to a rotor 13 such that the swing shaft 11 and the rotor 13 rotate integrally. Ends of two wires made of titanium-nickel based shape-memory alloy, that is, a left SMA wire 14L and a right SMA wire 14R, are fixed to a circumferential surface of the substantially cylindrical rotor 13. The left SMA wire 14L is wound about the circumferential surface of the rotor 13 counterclockwise as viewed in FIG. 1 from the fixed end, and is then drawn rearward and leftward from the rotor 13. On the other hand, the right SMA wire 14R is wound about the circumferential surface of the rotor 13 clockwise as viewed in FIG. 1 from the fixed end, and is then drawn rearward and rightward from the rotor 13. The rotation range of the rotor 13 is properly limited by a stopper (not shown).

The left and right SMA wires 14L, 14R drawn from the rotor 13 are wound about fixed pulleys 15L, 15R, which are located rearward and leftward and rightward of the rotor 13, respectively. The left and right SMA wires 14L, 14R are drawn rearward from the fixed pulleys 15L, 15R are wound about movable pulleys 16L, 16R for preventing looseness, respectively. The movable pulleys 16L, 16R are rotatably supported at ends of swing arms 18L, 18R, and located rearward of the fixed pulleys 15L, 15R. The swing arms 18L, 18R are swingably supported substantially at the center. Coil springs 19L, 19R in an extended state are fixed to ends of the swing arms 18L, 18R opposite to the ends to which the movable pulleys 16L, 16R are supported. The coil springs 19L, 19R constantly urge the swing arms 18L, 18R in directions to pull the movable pulleys 16L, 16R backward. When the SMA wires 14L, 14R are extended, the coil springs 19L, 19R swing the swing arms 18L, 18R to pull the movable pulleys 16L, 16R backward. As a result, the total length of each of the SMA wires 14L, 14R is extended, which prevents the looseness of the SMA wires 14L, 14R. Stoppers 17L, 17R are located forward of the swing arms 18L, 18R, respectively. Contact between the stoppers 17L, 17R and the swing arms 18L, 18R limits the range of swinging of the swing arms 18L, 18R in a direction pushing the movable pulleys 16L, 16R forward.

The ends of the SMA wires 14L, 14R, which are drawn forward from the looseness prevention movable-pulleys 16L, 16R, are fixed to a swing arms 21L, 21R of current shutoff mechanisms 20L, 20R. The current shutoff mechanisms 20L, 20R are used for forcibly shutting off the supply of current when the SMA wires 14L, 14R are excessively heated. The swing arms 21L, 21R of the current shutoff mechanisms 20L, 20R are swingably supported substantially at the center. The ends of the SMA wires 14L, 14R are fixed to ends of the swing arms 21L, 21R. Coil springs 23L, 23R are fixed to the other ends of the swing arms 21L, 21R in an extended state. Movable electrodes 24L, 24R project from the front side of the ends of the swing arms 21L, 21R to which the ends of the SMA wires 14L, 14R are fixed. The swing arms 21L, 21R are constantly urged to push the fixed ends of the SMA wires forward by the coil springs 23L, 23R. Accordingly, the movable electrodes 24L, 24R are pressed against plate-like fixed electrodes 25L, 25R, which are fixed at positions forward of the swing arms 21L, 21R.

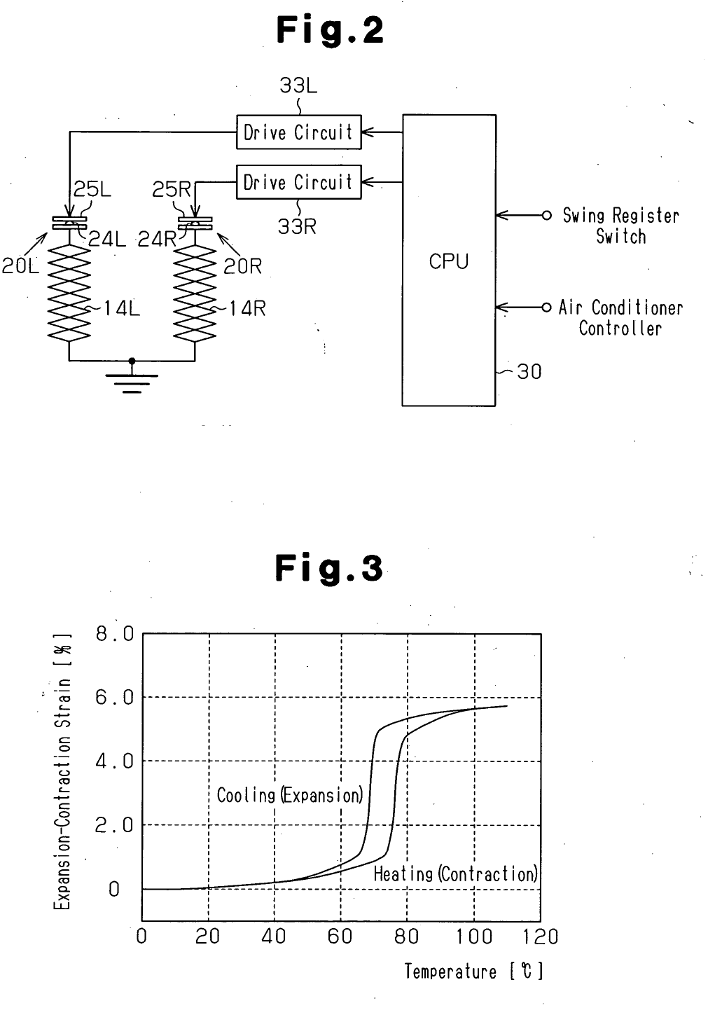

FIG. 2 shows the electrical configuration of the louver driver of the swing register according to the present embodiment. Currents to the SMA wires 14L, 14R are controlled by a central processing unit (CPU) 30, or an electricity supply control unit, shown in FIG. 2. The CPU 30 is electrically connected to a swing register switch located in the passenger compartment, and receives command signals from an air conditioner controller that controls the entire vehicle air conditioner. Automatic swinging of the vertical louvers 10a to 10e (see FIG. 1) by the louver driver is permitted when the swing register switch is closed (turned on), and is inhibited when the swing register switch is opened (turned off). The air conditioner controller determines the temperature and the flow rate of airflow in accordance with detection results of the outside temperature and the temperature in the passenger compartment and with manipulation by an occupant. The air conditioner controller also determines the mode of swinging of the vertical louvers 10a to 10e (see FIG. 1) and commands the CPU 30, accordingly.

The CPU 30 is also connected to drive circuits 33L, 33R of the SMA wires 14L, 14R. The drive circuit 33L, 33R supply current to the SMA wires 14L, 14R based on commands from the CPU 30, respectively. The SMA wires 14L, 14R are each electrically connected to the drive circuits 33L, 33R through contact points of the movable electrodes 24L, 24R and the fixed electrodes 25L, 25R of the current shutoff mechanisms 20L, 20R, respectively. The SMA wires 14L, 14R are grounded at the ends fixed to the rotor 13 (see FIG. 1).

The louver driver of the swing register as described above uses contraction of the SMA wires 14L, 14R made of titanium-nickel based alloy caused by electrical heating, thereby swings the vertical louvers 10a to 10e. The configuration of the material used for the SMA wires 14L, 14R is anisotropic such that the deformation when regaining the original geometry is limited in the lengthwise direction, that is, the direction of extension and contraction. When cooled, the SMA wires 14L, 14R are relaxed and can be extended by external pulling force. When heated, the SMA wires 14L, 14R contract to regain the original geometry and hardened. FIG. 3 shows one example of a graph of temperature versus strain of the SMA wires 14L, 14R. As shown in FIG. 3, the SMA wires 14L, 14R start contracting approximately at 80° C. when heated, and start being relaxed and extending approximately at 75° C. when cooled. The temperature at which the SMA wires 14L, 14R start contracting and the temperature at which the SMA wires 14L, 14R start being relaxed and extending are adjustable to a certain degree by quality governing of the alloy. The SMA wires 14L, 14R have a relatively great electrical resistance, and are readily heated by application of a current. The SMA wires 14L, 14R, which are made of a titanium-nickel based shape-memory alloy, have been developed as wires that are capable of repeatedly and stably generating maximum dynamic strains of 5% or greater with respect to the entire lengths when regaining the original geometry through electrical heating.

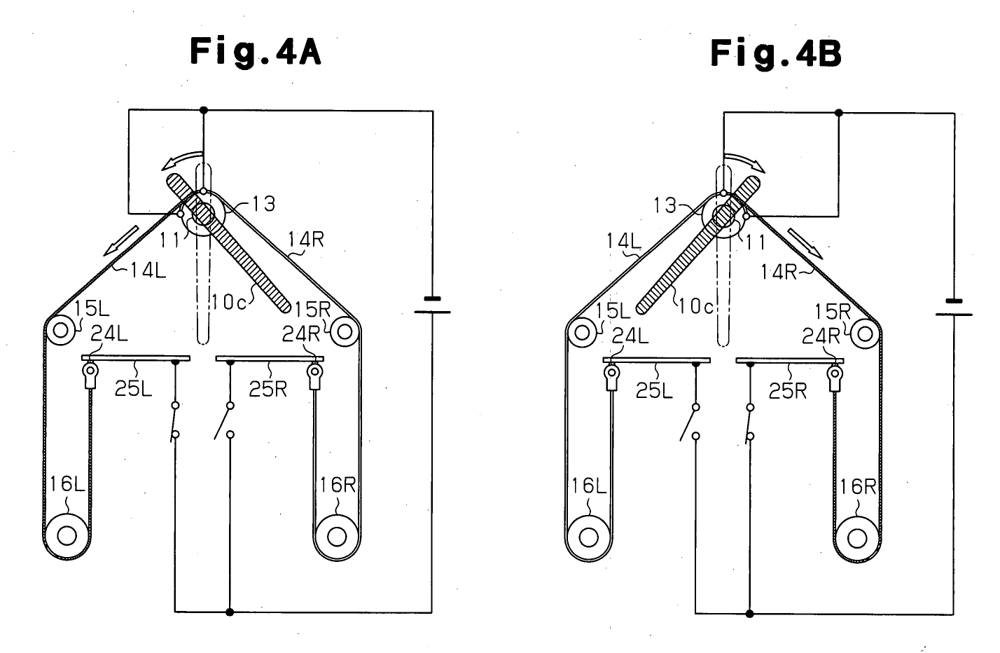

Next, the principle of operation of the swing register will be described. The louver driver of the swing register swings the vertical louvers 10a to 10e using contraction of the SMA wires 14L, 14R caused by electrical heating. When only the left SMA wire 14L is electrically heated, the left SMA wire 14L contracts accordingly as shown in FIG. 4A. At this time, the right SMA wire 14R, which is in a non-heated state, or cooled state, is relaxed and elastically extendible by pulling. The rotor 13 is thus rotated counterclockwise. As a result, the vertical louver 10c, which is fixed to the swing shaft 11 so as to be integrally movable with the rotor 13, is swung counterclockwise as viewed in the drawing. In contrast, when only the right SMA wire 14R is electrically heated, the right SMA wire 14R contracts accordingly as shown in FIG. 4B. At this time, the left SMA wire 14L, which is in a cooled state, is relaxed and elastically extendible by pulling. The rotor 13 is thus rotated clockwise. As a result, the vertical louver 10c, which is fixed to the swing shaft 11 so as to be integrally movable with the rotor 13, is swung clockwise as viewed in the drawing. In this manner, by alternately supplying current to the left and right SMA wires 14L, 14R, the vertical louver 10c is swung alternately leftward and rightward periodically. By continuously supplying the current to either of the SMA wires 14L, 14R such that the contraction strain rate is maintained at an appropriate value, the swing angle of the vertical louver 10c is maintained. Accordingly, the direction of the airflow from the duct outlet is fixed.

In the manner described above, the louver driver of the swing register uses the SMA wires 14L, 14R as a driving source. When the SMA wires 14L, 14R are supplied with excessive current, the temperature of the SMA wires 14L, 14R can surpass an upper limit of a proper temperature range. If such an excessive heated state continues, permanent strain is caused in the SMA wires 14L, 14R by their own contraction force, which degrades the geometry regaining property. As a result, the vertical louvers 10a to 10e will be unable to swing properly. Therefore, in this embodiment, when the SMA wires 14L, 14R excessively contract due to excessive heating, the current shutoff mechanisms 20L, 20R forcibly shut off the current so that the excessively heated state does not continue.

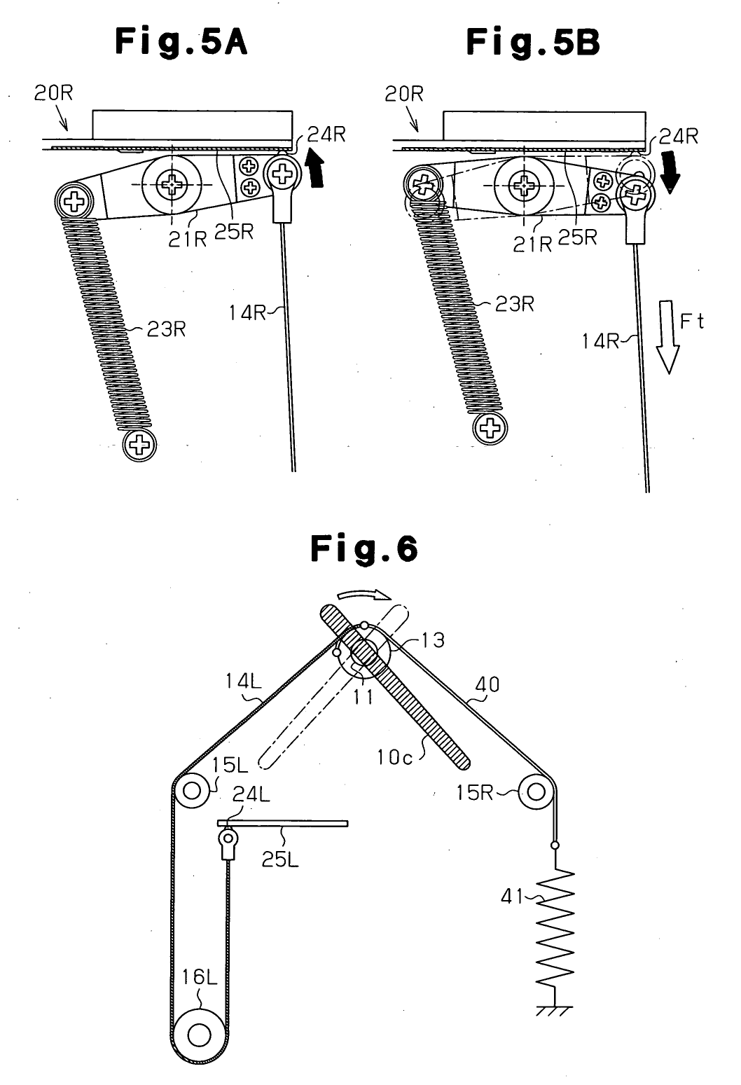

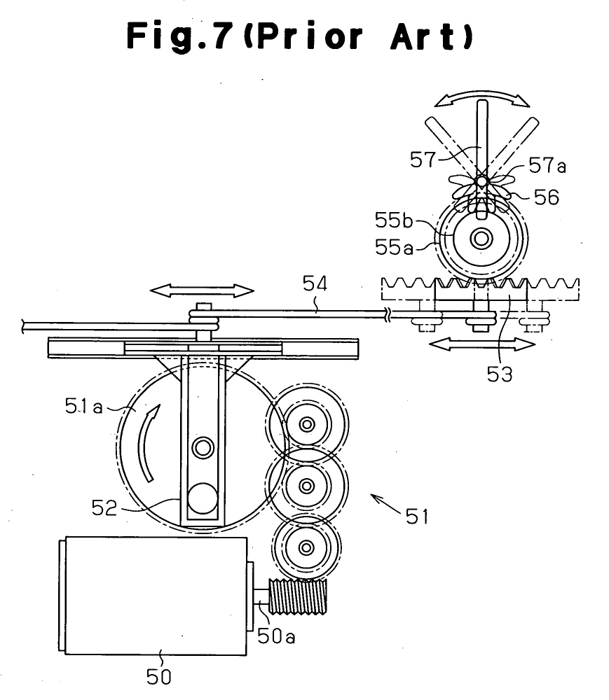

An example of the operation of the current shutoff mechanism 20L, 20R will now be described with reference to FIGS. 5A and 5B. Although FIGS. 5A and 5B show the operation of only the left current shutoff mechanism 20L, the operation of the current shutoff mechanism 20R operates in the same manner.

In the non-heated state, the movable electrode 24R provided at one end of the swing arm 21R of the current shutoff mechanisms 20R is pressed against the plate-like fixed electrode 25R by the force of the coil spring 23R fixed to the other end of the swing arm 21R (21L) in the extended state. The current path of the SMA wire 14R is maintained by the contact between the movable electrode 24R and the fixed electrode 25R. The moment applied to the swing arm 21R by the force of the coil spring 23R is set slightly less than the moment applied to swing arm 21R by the tension of the SMA wire 14R when the tension is at the upper limit in the allowable range (maximum allowable tension). Therefore, in the non-heated state, the contraction of the SMA wire 14R by the electrical heating is not totally cancelled by contraction of the coil spring 23R and the accompanying swinging motion of the swing arms 21R.

On the other hand, when the SMA wire 14R excessively contracts due to excessive heating, rotation of the rotor 13 (refer to FIG. 1) is restricted by the stopper so that further contraction of the SMA wire 14R is limited. Accordingly, the tension Ft of the SMA wire 14R is increased. When the tension Ft is increased to reach a value near the maximum allowable tension, the swing arm 21R is swung against the force of the coil spring 23R as shown in FIG. 5B, so that the movable electrode 24R separates from the fixed electrode 25R. As a result, the current path to the SMA wire 14R is cut, and the supply of current is forcibly shut off.

The louver driver of the swing register according to the above described embodiment has the following advantages.

(1) In the above embodiment, the vertical louvers 10a to 10e are driven by using the contraction of the shape-memory alloy (the SMA wires 14L, 14R), which generates no sound when operating, through electrical heating. Therefore, noise generated during the operation of the vertical louvers 10a to 10e is readily and reliably reduced. As a result, no sound insulating member is required. This reduces the weight and the occupied space the louver driver.

(2) When the SMA wires 14L, 14R are excessively heated and contract excessively, the contraction force separates the movable electrodes 24L, 24R from the fixed electrodes 25L, 25R, so that the supply of current to the SMA wires 14L, 14R is forcibly cut off. Thus, the geometry regaining property of the SMA wires 14L, 14R is prevented from deteriorating due to excessive heating. Accordingly, the operation property of the louver driver of the swing register is prevented from being degraded.

(3) The SMA wires 14L, 14R are wound about the circumferential surface of the rotor 13, which is coupled to and rotates integrally with the swing shaft 11 of the vertical louver 10c, and the ends of the SMA wires 14L, 14R are fixed to the circumferential surface of the rotor 13. This permits contraction of the SMA wires 14L, 14R to be directly converted into rotation of the swing shaft 11. Therefore, the vertical louvers 10a to 10e can be readily swung without providing a linear-to-rotary conversion mechanism such as a rack-and-pinion.

(4) When the vertical louver 10c is forcibly and manually swung by an occupant of the vehicle, such movement is absorbed by the elastic deformation of the SMA wires 14L, 14R. Thus, a clutch mechanism that is required for a conventional louver driver using a DC motor can be omitted.

(5) The swinging motion of the vertical louvers 10a to 10e are easily and accurately adjusted by controlling the current supplied to the left-and right two SMA wires 14L, 14R.

The above embodiment may be modified as follows.

In the illustrated embodiment, leftward and rightward swinging motion of the vertical louvers 10a to 10e are achieved by contraction of the left and right SMA wires 14L, 14R due to electrical heating. However, it may be configured that either one of the leftward and rightward swinging motions of the vertical louvers 10a to 10e is achieved by contraction of an SMA wire, and the swinging motion in the other direction is achieved by the force of a spring. FIG. 6 illustrates one example of such a configuration. In this louver driver, the right SMA wire 14R is replaced by a wire 40. The wire 40 is made of a normal metal that is not shape-memory alloy. One end of the wire 40 is wound about and fixed to the circumferential surface of the rotor 13. The other end of the wire 40, which extends from the rotor 13, is coupled to a coil spring 41. The other end of the coil spring 41 is fixed to the vehicle body. The force of the coil spring 41 is sufficiently smaller than the contraction force generated by the SMA wire 14L by electrical heating. In this louver driver of the swing register, when the SMA wire 14L contracts through electrical heating, the rotor 13, together with the louver 10c, is rotated counterclockwise against to the force of the coil spring 41. When the supply of current is shut off to cool the SMA wire 14L, the SMA wire 14L is relaxed and extended by the force of the coil spring 41, which causes the rotor 13, together with vertical louver 10c, to rotate clockwise. This configuration permits the vertical louvers 10a to 10e to be swung in the similar manner as in the above illustrated embodiment. In the. configuration of FIG. 6, the vertical louvers 10a to 10e are swung leftward by contraction of the SMA wire 14L and swung rightward by the extension of the SMA wire 14L by the force of the coil spring 41 when the SMA wire 14L is cooled, and the SMA wire 14L generates no sound during operation. Therefore, noise generated during the operation of the vertical louver 10c is readily and reliably reduced as in the above illustrated embodiment.

In the embodiment of FIGS. 1 to 5B, the current shutoff mechanisms 20L, 20R are provided for forcibly shutting off the supply of current to prevent the SMA wires 14L, 14R from being excessively heated. However, the current shutoff mechanisms 20L, 20R may be omitted in the case where prevention circuits are provided for preventing excessive current to the SMA wires 14L, 14R.

In the embodiment of FIGS. 1 to 5B, the rotor 13 is integrated with the swing shaft 11 of the vertical louver 10c. However, the rotor 13 may be coupled to the swing shaft 11 of the rotor 13 by means of a power transmission mechanism such as gears in such a manner that the rotor 13 rotates synchronously with the swing shaft 11.

In the embodiment of FIGS. 1 to 5B, the SMA wires 14L, 14R are wound about and fixed to the circumferential surface of the rotor 13, so that linear motion caused by contraction of the SMA wires 14L, 14R is directly converted into rotation of the rotor 13 and to swinging motion of the vertical louver 10c. However, the linear-to-swing conversion may be achieved by another mechanism such as a rack-and-pinion. In such a case, the rack is caused to reciprocate by contraction of the SMA wires 14L, 14R, and is meshed with a pinion that is coupled to the swing shaft 11 of the vertical louver 10c to synchronously rotate with the swing shaft 11, so that the vertical louver 10c is swung.

In the embodiment of FIGS. 1 to 5B, the vertical louver 10c is swung by means of the SMA wires 14L, 14R made of a shape-memory alloy. However, the vertical louver 10c may be swung by a shape-memory alloy formed into another shape such as a coil spring. That is, as long as a shape-memory alloy that contracts due to electrical heating is used, and the metal and louvers are coupled to each other such that the louvers are swung due to contraction of the metal, the present invention may be embodied as any type of louver driver in a swing register that generates significantly reduced noise.

As long as the shape-memory alloy used in the embodiments has a sufficiently great amount of geometry regaining and contraction force, any shape-memory alloy other than titanium-nickel based shape-memory alloy may be used as the driving source of the louvers.

The louver driver of the swing register according to the present invention may be applied as a mechanism for vertically swinging the lateral louvers.

1. A louver driver used in a swing register that swings louvers that are pivotally supported at an airflow passage of an air conditioner, thereby changing the course of the airflow, the louver driver comprising:
a shape-memory alloy member that is extended and contracted when electrically heated, wherein the shape-memory alloy member and the louver are coupled to each other such that the louver is swung in accordance with extension and contraction of the shape-memory alloy.

2. The louver driver according to claim 1, wherein the shape-memory alloy member is one of two shape-memory alloy members, and wherein the louver is swung in one direction when one of the shape-memory alloy members is electrically heated, and is swung in another direction when the other shape-memory alloy member is electrically heated.

3. The louver driver according to claim 2, further comprising an electricity supply control unit that alternately supplies electricity to the two shape-memory alloy members.

4. The louver driver according to claim 1, wherein the louver has a swing shaft, the louver driver further comprising a rotor that is coupled to and rotates integrally with the swing shaft, wherein the shape-memory alloy member is a wire wound about a circumferential surface of the rotor, one end of the wire being fixed to the circumferential surface of the rotor.

5. The louver driver according to claim 4, wherein the wire is made of a titanium-nickel based shape-memory alloy.

6. The louver driver according to claim 4, wherein the wire is capable of repeatedly generate maximum dynamic strains of 5% or greater with respect to the entire length when regaining the original geometry through electrical heating.

7. The louver driver according to claim 1, wherein the louver is a main louver, the louver driver further comprising:
a plurality of follower louvers; and
a link mechanism,
wherein the main blade and the follower louvers are mechanically coupled to each other by a link mechanism so that the louvers are swung synchronously.

8. The louver driver according to claim 1, wherein the swing register is used in a vehicle.
